(19) United States
(12) Patent Application Publication
(10) Pub. No.: US 2024/0387851 A1
(43) Pub. Date: Nov. 21, 2024

(54) PERYLENEQUINONES FOR REDOX APPLICATIONS

(71) Applicants: THE UNIVERSITY OF NORTH CAROLINA AT CHARLOTTE, Charlotte, NC (US); THE UNIVERSITY OF NORTH CAROLINA AT GREENSBORO, Greensboro, NC (US)

(72) Inventors: Nicholas Oberlies, Greensboro, NC (US); Shabnam Hematian, Greensboro, NC (US); Michael G. Walter, Charlotte, NC (US); Cedric Pearce, Chapel Hill, NC (US)

(21) Appl. No.: 18/669,078

(22) Filed: May 20, 2024

Related U.S. Application Data
(60) Provisional application No. 63/467,692, filed on May 19, 2023.

(51) Int. Cl. H01M 8/18; H01M 8/02; H01M 8/08

(52) U.S. Cl. CPC H01M 8/188; H01M 8/02; H01M 8/08

(57) ABSTRACT

Environmentally sustainable redox species are needed for various applications, including RFB anolyte and/or catholyte materials and photoredox catalyst. Ideally, such environmentally sustainable redox species can be sourced from nature or are otherwise renewable. In some embodiments, redox flow batteries are described herein comprising anolyte and catholyte, wherein at least one of the anolyte and catholyte comprises perylenequinone electrolyte.

### RELATED APPLICATION DATA

The present application claims priority pursuant to 35 U.S.C. § 119 (e) to U.S. Provisional Patent Application Ser. No. 63/467,692 filed May 19, 2023 which is incorporated herein by reference in its entirety.

### STATEMENT OF GOVERNMENT RIGHTS

This invention was made with government support under grant P01-CA1125066 awarded by the National Cancer Institute (NCI) and the National Institutes of Health (NIH) and grant DE-SC0024433 awarded by the Office of Science (Materials Chemistry Program) of the Department of Energy (DOE). The government has certain rights in the invention.

### FIELD

The present invention relates to conjugated molecular species and, in particular, to perylenequinones for various redox applications.

### BACKGROUND

Energy plays a vital role in modern society. Our everyday activities, ranging from the operation of factories, businesses, and transportation systems to powering of our homes, hospitals, and schools, depend on the ability to produce, store, transport, and consume energy in a sustainable way.

Recognizing the challenges of energy security and the impact of our current energy portfolio on climate change, many governments have prioritized the development and commercialization of sustainable next-generation technologies that can both protect the environment and drive the economy. To this end, it is critical to decarbonize our energy landscape and establish possible ways forward for the production and storage of net-zero-carbon energy solutions.

Natural processes, such as photosynthesis in plants, have been optimized over billions of years of evolution. Historically, natural products have played critical roles in drug discovery and development, especially for cancer. Renewable energy sources such as solar, wind, or hydropower are key solutions to power the future. However, their intermittent nature does not always align with typical energy demand. In order to realize the full potential of such green energy sources, there is an urgent need to integrate scalable energy storage that can capture and hold energy until it is needed, such as redox flow batteries (RFBs). Current RFB architectures face various challenges, including the use of environmentally unfriendly redox species. Additionally, the use of light for driving reactions, particularly photoredox catalysis, provides an attractive avenue for sustainable organic synthesis. There is substantial interest in shifting away from expensive and toxic transition metal molecular catalysts, often utilizing iridium and ruthenium, towards greener alternatives.

### SUMMARY

In view of the foregoing, environmentally sustainable redox species are needed for various applications, including RFB anolyte and/or catholyte materials and photoredox catalyst. Ideally, such environmentally sustainable redox species can be sourced from nature or are otherwise renewable. In some embodiments, redox flow batteries are described herein comprising anolyte and catholyte, wherein at least one of the anolyte and catholyte comprises perylenequinone electrolyte. In some embodiments, the same perylenequinone electrolyte is employed as the anolyte and the catholyte, thereby providing a symmetrical RFB. Such symmetrical chemistries can mitigate or eliminate cell degradation mechanisms, including crossover. Moreover, symmetrical chemistries can simplify battery design and facilitate long term maintenance. Alternatively, in some embodiments, only one of the anolyte and catholyte comprises perylenequinone electrolyte, thereby establishing an asymmetric architecture.

In some embodiments, perylenequinones suitable for use in anolyte and/or catholyte are of Formula I:

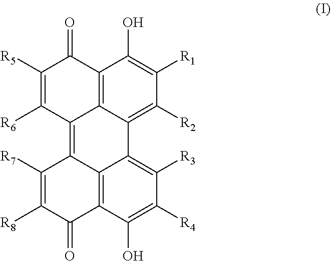

wherein R¹-R⁸ are independently selected from the group consisting of hydrogen, alkyl, alkenyl, heteroalkyl, heteroalkenyl, cycloalkyl, heterocycloalkyl, heterocycle, aryl, heteroaryl, amine, halo, hydroxy, alkoxy, amide, ether, ketone, —C(O)O^{—}, —C(O)OR₉, and —R₁₀OH, wherein R₉ is selected from the group consisting of hydrogen and alkyl, and R₁₀ is alkyl; and wherein two or more of R₁-R₄ may optionally combine to form one or more cyclic structures optionally substituted with one or more substituents selected from the group consisting of alkyl, alkoxy, hydroxy, imine, amine, amide, ketone, —C(O)O^{—}, —C(O)OR₁₁, and —R₁₂OH, wherein R₁₁ is selected from the group consisting of hydrogen and alkyl, and R₁₂ is alkyl; and wherein two or more of R₅-R₈ may optionally combine to form one or more cyclic structures optionally substituted with one or more substituents selected from the group consisting of alkyl, alkoxy, hydroxy, imine, amine, amide, ketone, —C(O)O^{—}, —C(O)OR₁₃, and —R₁₄OH, wherein R₁₃ is selected from the group consisting of hydrogen and alkyl, and R₁₄ is alkyl. When present, the optional cyclic structures formed from two or more of R₁-R₄ and/or two or more of R₅-R₈ are independently selected from the group consisting of cycloalkyl, heterocycloalkyl, cycloalkenyl, heterocycloalkenyl, heterocycle, aryl, and heteroaryl.

In some embodiments, perylenequinones suitable for employment as electrolytes in RFBs are naturally derived from fungal sources or plant secondary metabolites. Moreover, anolyte and/or catholyte comprising perylenequinones can employ aqueous or aqueous-based solvents or organic solvents. In some embodiments, suitable organic solvents comprise polar organic solvents.

In another aspect, methods of alkylation are described herein. A method of alkylation, in some embodiments, comprises providing a reaction mixture including a perylenequinone photoredox catalyst, an alkyl source, and a substrate. The perylenequinone photoredox catalyst is excited via irradiation. The excited perylenequinone photoredox catalyst subsequently oxidizes the alkyl source, thereby forming an alkyl radical and reduced perylenequinone photoredox catalyst. The alkyl radical reacts with the substrate followed by single electron transfer from the reduced perylenequinone photoredox catalyst to the alkylated substrate. In some embodiments, natural or naturally-derived perylenequinones can serve as photocatalysts for alkylation reactions described herein. In some embodiments, perylenequinone photoredox is of Formula I:

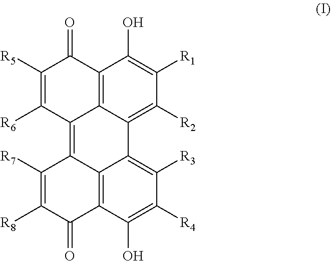

wherein R₁-R₈ are independently selected from the group consisting of hydrogen, alkyl, alkenyl, heteroalkyl, heteroalkenyl, cycloalkyl, heterocycloalkyl, heterocycle, aryl, heteroaryl, amine, halo, hydroxy, alkoxy, amide, ether, ketone, —C(O)O^{—}, —C(O)OR₉, and —R₁₀OH, wherein R₉ is selected from the group consisting of hydrogen and alkyl, and Rio is alkyl; and wherein two or more of R₁-R₄ may optionally combine to form one or more cyclic structures optionally substituted with one or more substituents selected from the group consisting of alkyl, alkoxy, hydroxy, imine, amine, amide, ketone, —C(O)O^{—}, —C(O)OR₁₁, and —R₁₂OH, wherein R₁₁ is selected from the group consisting of hydrogen and alkyl, and R₁₂ is alkyl; and wherein two or more of R₅-R₈ may optionally combine to form one or more cyclic structures optionally substituted with one or more substituents selected from the group consisting of alkyl, alkoxy, hydroxy, imine, amine, amide, ketone, —C(O)O^{—}, —C(O)OR₁₃, and —R₁₄OH, wherein R₁₃ is selected from the group consisting of hydrogen and alkyl, and R₁₄ is alkyl. When present, the optional cyclic structures formed from two or more of R₁-R₄ and/or two or more of R₅-R₈ are independently selected from the group consisting of cycloalkyl, heterocycloalkyl, cycloalkenyl, heterocycloalkenyl, heterocycle, aryl, and heteroaryl.

These and other embodiments are further described in the following detailed description.

### BRIEF DESCRIPTION OF THE DRAWINGS

FIG. 1 provides several examples of perylenequinones for use as anolyte and/or catholyte in redox flow batteries described herein.

FIG. 2(a) provides normalized cyclic voltamograms (CV) of a series of perylenequinones in acetonitrile with 100 mM of [(nBu₄)N][PF₆].

FIG. 2(b) provides the CV in an aqueous solution for hypocrellin B (HB) illustrating the highly reversible electron transfer processes.

FIG. 2(c) provides a Randles-Sevcik plot for HB.

FIG. 2(d) illustrates HB interconverting between the highly charged and aqueous-soluble HB^{2—/4—} forms along with an organic catholyte containing the organic-soluble HB species, HB^{2—/0}. FIG. 3 illustrates various imine substrates and alkyl sources according to some embodiments herein.

FIG. 4(a) provides a reaction scheme for alkylation of diphenylimine, according to some embodiments.

FIG. 4(b) illustrates a mechanism for photocatalytic alkylation of diphenylimine, according to some embodiments.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### Definitions

The term “alkyl” as used herein, alone or in combination, refers to a straight or branched saturated hydrocarbon group optionally substituted with one or more substituents. For example, an alkyl can be C₁-C₃₀ or C₁-C₁₈.

The term “alkenyl” as used herein, alone or in combination, refers to a straight or branched chain hydrocarbon group having at least one carbon-carbon double bond and optionally substituted with one or more substituents.

The term “aryl” as used herein, alone or in combination, refers to an aromatic monocyclic or multicyclic ring system optionally substituted with one or more ring substituents.

The term “heteroaryl” as used herein, alone or in combination, refers to an aromatic monocyclic or multicyclic ring system in which one or more of the ring atoms is an element other than carbon, such as nitrogen, boron, oxygen and/or sulfur.

The term “heterocycle” as used herein, alone or in combination, refers to a mono-or multicyclic ring system in which one or more atoms of the ring system is an element other than carbon, such as boron, nitrogen, oxygen, and/or sulfur or phosphorus and wherein the ring system is optionally substituted with one or more ring substituents. The heterocyclic ring system may include aromatic and/or non-aromatic rings, including rings with one or more points of unsaturation.

The term “cycloalkyl” as used herein, alone or in combination, refers to a non-aromatic, mono-or multicyclic ring system optionally substituted with one or more ring substituents.

The term “heterocycloalkyl” as used herein, alone or in combination, refers to a non-aromatic, mono-or multicyclic ring system in which one or more of the atoms in the ring system is an element other than carbon, such as boron, nitrogen, oxygen, sulfur or phosphorus, alone or in combination, and wherein the ring system is optionally substituted with one or more ring substituents.

The term “alkoxy” as used herein, alone or in combination, refers to the moiety RO—, where R can be alkyl, alkenyl, or aryl defined above.

The term “halo” as used herein, alone or in combination, refers to elements of Group VIIA of the Periodic Table (halogens). Depending on chemical environment, halo can be in a neutral or anionic state.

Terms not specifically defined herein are given their normal meaning in the art.

### I. Redox Flow Batteries

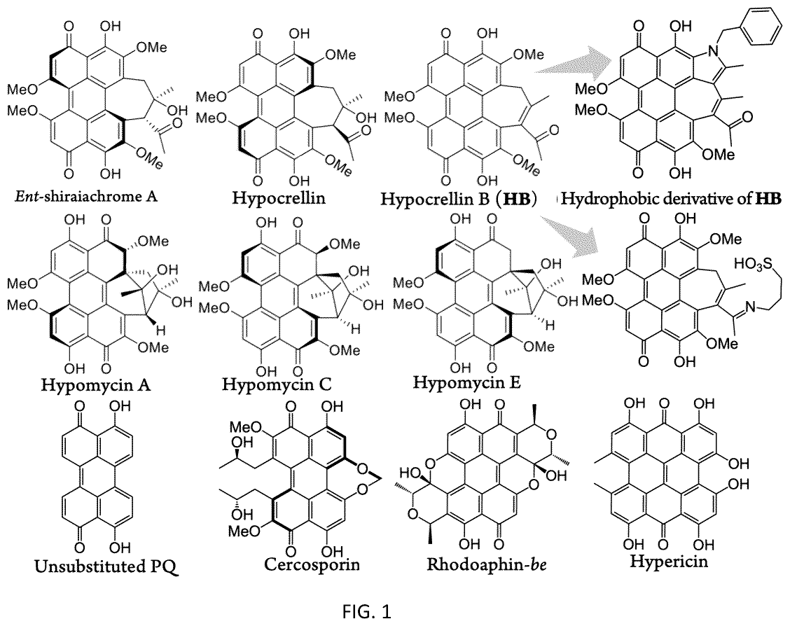

In one aspect, redox flow batteries are described herein employing perylenequinone electrolyte. A redox flow battery, in some embodiments, comprises an anolyte and catholyte, wherein at least one of the anolyte and catholyte comprises perylenequinone electrolyte. In some embodiments, perylenequinones suitable for use in anolyte and/or catholyte is of Formula I:

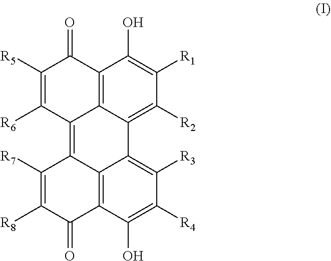

wherein R₁-R₈ are independently selected from the group consisting of hydrogen, alkyl, alkenyl, heteroalkyl, heteroalkenyl, cycloalkyl, heterocycloalkyl, heterocycle, aryl, heteroaryl, amine, halo, hydroxy, alkoxy, amide, ether, ketone, —C(O)O^{—}, —C(O)OR₉, and —R₁₀OH, wherein R₉ is selected from the group consisting of hydrogen and alkyl, and Rio is alkyl; and wherein two or more of R₁-R₄ may optionally combine to form one or more cyclic structures optionally substituted with one or more substituents selected from the group consisting of alkyl, alkoxy, hydroxy, imine, amine, amide, ketone, —C(O)O^{—}, —C(O)OR₁₁, and —R₁₂OH, wherein Rn is selected from the group consisting of hydrogen and alkyl, and R₁₂ is alkyl; and wherein two or more of R₅-R₈ may optionally combine to form one or more cyclic structures optionally substituted with one or more substituents selected from the group consisting of alkyl, alkoxy, hydroxy, imine, amine, amide, ketone, —C(O)O⁻, —C(O)OR₁₃, and —R₁₄OH, wherein R₁₃ is selected from the group consisting of hydrogen and alkyl, and R₁₄ is alkyl. When present the optional cyclic structures formed from two or more of R₁-R₄ and/or two or more of R₅-R₈ are independently selected from the group consisting of cycloalkyl, heterocycloalkyl, cycloalkenyl, heterocycloalkenyl, heterocycle, aryl, and heteroaryl. FIG. 1 provides several examples of perylenequinones for use in anolyte and/or catholyte of redox flow batteries described herein. In some embodiments, hypocrellins and hypomycins (A, B, C, E) can be used to provide anolyte and/or catholyte.

Anolyte and catholyte can comprise aqueous or organic solvents. In some embodiments, organic solvents comprise polar organic solvents including acetone, acetonitrile, dimethylformamide (DMF), dimethylsulfoxide (DMSO), γ-valerolactone (GVL), and alcohols such as methanol, ethanol, and isopropanol. Suitable polar organic solvents can also be aprotic.

Alternatively, anolyte and catholyte can be aqueous or aqueous-based. In some embodiments, pH of aqueous or aqueous-based solvents ranges from 0-5 or 9-12. Higher pH values can induce deprotonation of various functional groups or moieties depending on specific pKₐ values and perylenequinone structure. Such deprotonation can enhance solubilities of perylenequinones in aqueous or aqueous-based solvent of the anolyte and/or catholyte. Solubilities of perylenequinones in aqueous and/or organic phases can be further altered with suitable supporting electrolytes, hybrid solvents (i.e., mixing aqueous and miscible non-aqueous solvents), ionic liquid electrolytes, and macromolecular crowding agents to tune the solubility and increase the aqueous electrolyte operation window.

Redox flow batteries described herein can exhibit symmetric and asymmetric architectures. In a symmetric architecture, the same perylenequinone is employed in anolyte and catholyte. In the asymmetric architecture, different perylenequinones can be used in the anolyte and catholyte. Alternatively, a perylenequinone can be paired with a non-perylenequinone redox species to provide the requisite anolyte and catholyte. Suitable non-perylenequinone redox species can include dialkoxybenzenes, quinones, nitroxide radicals, and heterocyclic aromatics such as methyl viologen, ABTS (2,2′-azino-bis(3-ethylbenzothiazoline-6-sulfonate)) salts, ferrocenes, ferricyanide, and metals including zinc and lithium, for example.

Redox flow batteries described herein can also employ a membrane or separator to isolate anolyte from catholyte. The membrane can be formed of any suitable material permitting the transfer of charge carriers (e.g., protons) while precluding mixing or cross-over of anolyte and catholyte species. In some embodiments, the membrane can comprise glass frits of appropriate porosities and pore size, as well as cation exchange membranes (e.g., Nafion-117 and Selemion-CMV) or anion-exchange membranes (e.g., Selemion-AMV and Aemion+). The membrane can have any properties and/or construction consistent with the technical objectives described herein.

In some embodiments, redox flow batteries described herein do not employ a membrane for anolyte/catholyte separation. In such embodiments, anolyte and catholyte with immiscible continuous phases can be used to preclude mixing or cross-over of anolyte and catholyte species. In some embodiments, for example, the anolyte is aqueous or aqueous-based and the catholyte is organic or vice versa. Immiscible phases, in some embodiments, include aqueous electrolytes paired with organic solvents including 2-methyl tetrahydrofuran (MeTHF), toluene, difluorobenzene, dichloromethane (DCM), 1,2-dichloroethane (DCE), ethyl acetate (EA), butanol, butyl acetate, dioxane, methyl ethyl ketone (MEK), propylene carbonate (PC), as well as ionic liquids (such as hydrophilic tetrabutylammonium ILs [N4444]HSO₄, [N4444]CH₃COO, [N4444] NO₃, [N4444] CF₃SO₃, [N4444] BF₄ and [N4444]H₂PO₄). Additionally, while some organic solvents are miscible with water, such as acetonitrile (MeCN), γ-valerolactone (GVL), dimethoxyethane (DME), tetraethylene glycol dimethyl ether (TEGDME), and ethylene carbonate (EC), their miscibility with water can be altered by the salt-out effect. For example, the use of ternary aqueous electrolytes (e.g., ZnSO₄, MgSO₄, and NH₄PF₆) as the aqueous phase and TBAPF₆ in MeCN as the organic phase can be used.

Redox active species in such immiscible systems can be symmetric or asymmetric. In some embodiments, the same perylenequinone can exhibit solubility in aqueous and organic phases based on oxidized and reduced forms of the perylenequinone. In other embodiments, a perylenequinone can be paired with a differing perylenequinone or non-perylenequinone species to provide an asymmetric redox architecture as described above.

The reduction of perylenequinones proceeds in a stepwise fashion in organic solvent while in aqueous electrolytes, the 2-electron processes typically occur in one step as a concerted proton coupled electron transfer (PCET) event. Due to the proton-coupled nature of the redox reactions of perylenequinone, adjusting the proton concentration (i.e., pH) of the aqueous electrolytes can be used to tune reduction potential. Cationic species (e.g., Li⁺/Na⁺/K⁺/Cs⁺/Mg²⁺/NH₄⁺/N(Me)₄⁺/N (nBu)₄⁺) can also be included in organic electrolytes and used as buffers in aqueous systems.

Electrodes of redox flow can comprise any material consistent with the technical objectives described herein. Electrodes can be formed of porous carbon architectures, including carbon paper, carbon felt, or graphite felt. Additionally, individual redox flow cells of any desired number can be arranged in series to provide enhanced electrical power from the redox flow battery. Such cells can be stacked or otherwise configured in spatially desired manner.

In some embodiments, redox flow batteries described herein exhibit an open circuit voltage greater than 1V. Open circuit voltage of a redox flow battery comprising perylenequinone anolyte and/or catholyte, for example, can have an open circuit voltage of 1.5V to 3V or 1.6 V to 2.5 V, in some embodiments.

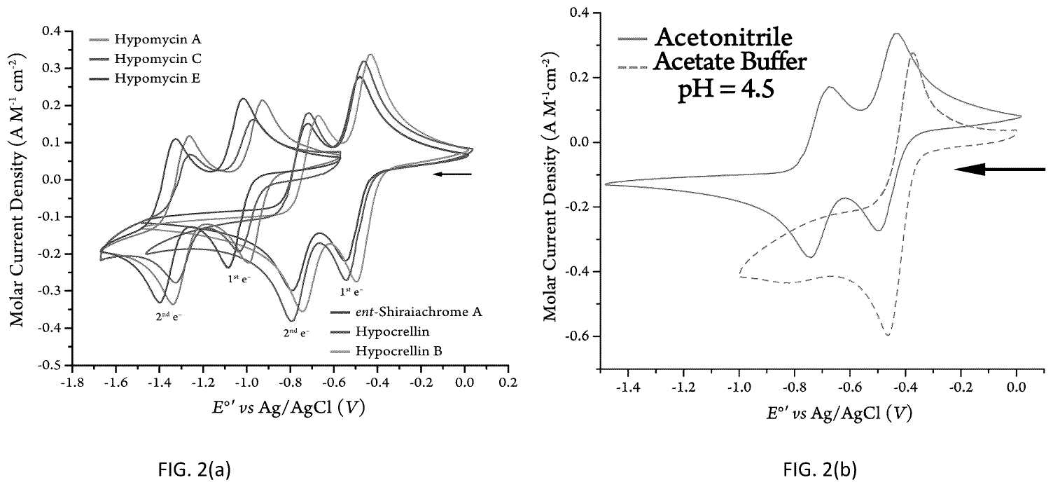

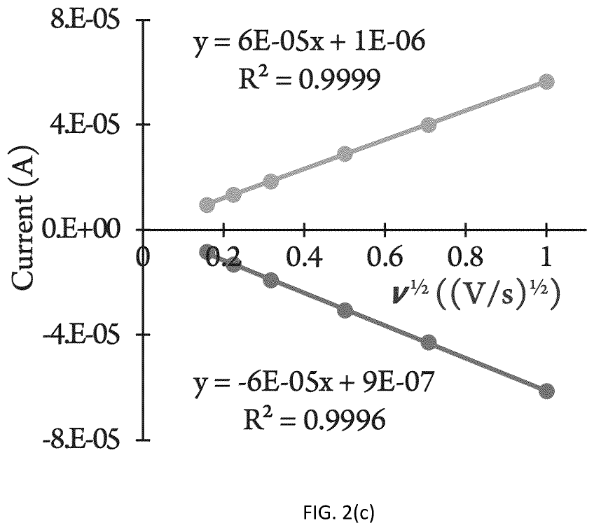

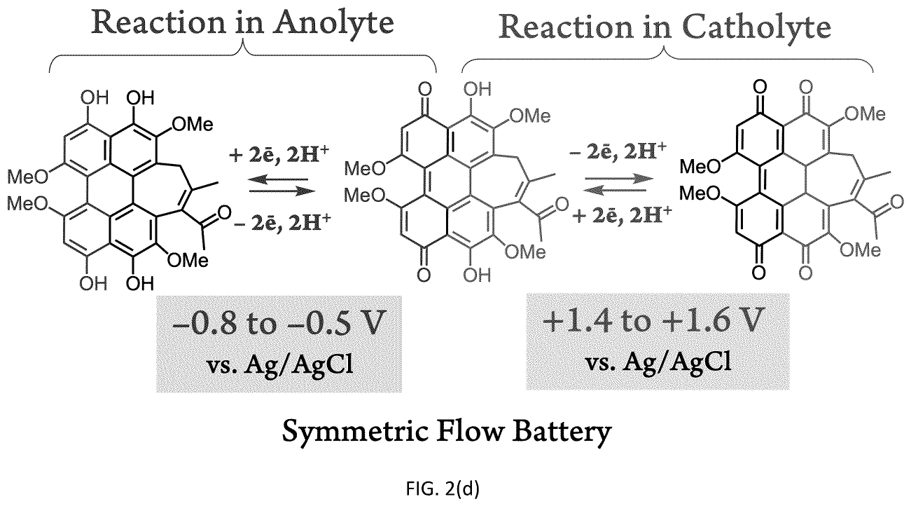

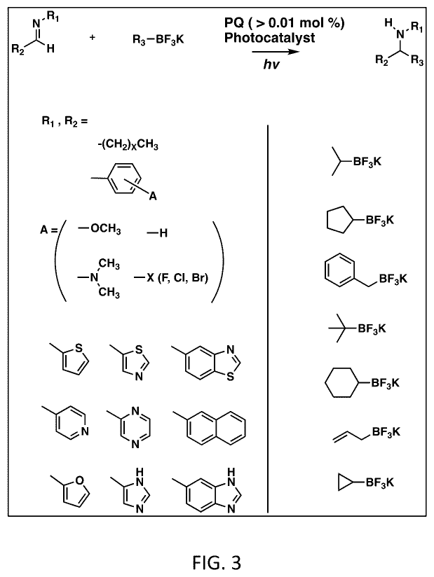

FIGS. 2(a)-2(b) illustrate several non-limiting embodiments of the foregoing principles. FIG. 2(a) provides normalized cyclic voltamograms (CV) of a series of perylenequinones in acetonitrile with 100 mM of [(nBu₄)N][PF₆], whereas FIG. 2(b) provides the CV in an aqueous solution for hypocrellin B (HB) illustrating the highly reversible electron transfer processes. FIG. 2(c) provides a Randles-Sevcik plot for HB. FIG. 2(d) illustrates HB interconverting between the highly charged and aqueous-soluble HB^{2-/4-} forms along with an organic catholyte containing the organic-soluble HB species, HB^{2-/0}, with lower net charge (e.g., in 2-methyl tetrahydrofuran). Such differing solubilities enable use of HB to construct a membrane-free or separator-free redox flow battery, as described herein.

### II. Photoredox Catalyst

In another aspect, methods of alkylation are described herein. A method of alkylation, in some embodiments, comprises providing a reaction mixture including a perylenequinone photoredox catalyst, an alkyl source, and a substrate. The perylenequinone photoredox catalyst is excited via irradiation for oxidation of the alkyl source, thereby forming an alkyl radical and reduced perylenequinone photoredox catalyst. The alkyl radical reacts with the substrate followed by single electron transfer from the reduced perylenequinone photoredox catalyst to the alkylated substrate. In some embodiments, natural or naturally-derived perylenequinones can serve as photocatalysts for alkylation reactions described herein. For example, in some embodiments, perylenequinone photoredox catalyst is selected from the group consisting of ent-shiraichrome A, hypocrellin B, hypomycin A, hypomycin C, and hypomycin E. In some embodiments, perylenequinone photoredox is of Formula I:

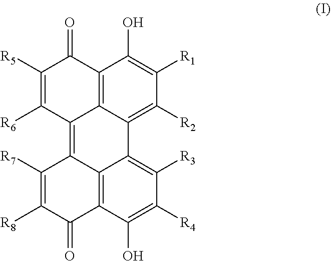

wherein R₁-R₈ are independently selected from the group consisting of hydrogen, alkyl, alkenyl, heteroalkyl, heteroalkenyl, cycloalkyl, heterocycloalkyl, heterocycle, aryl, heteroaryl, amine, halo, hydroxy, alkoxy, amide, ether, ketone, —C(O)O^{—}, —C(O)OR₉, and —R₁₀OH, wherein R₉ is selected from the group consisting of hydrogen and alkyl, and Rio is alkyl; and wherein two or more of R₁-R₄ may optionally combine to form one or more cyclic structures optionally substituted with one or more substituents selected from the group consisting of alkyl, alkoxy, hydroxy, imine, amine, amide, ketone, —C(O)O^{—}, —C(O)OR₁₁, and —R₁₂OH, wherein R₁₁ is selected from the group consisting of hydrogen and alkyl, and R₁₂ is alkyl; and wherein two or more of R₅-R₈ may optionally combine to form one or more cyclic structures optionally substituted with one or more substituents selected from the group consisting of alkyl, alkoxy, hydroxy, imine, amine, amide, ketone, —C(O)O^{—}, —C(O)OR₁₃, and —R₁₄OH, wherein R₁₃ is selected from the group consisting of hydrogen and alkyl, and R₁₄ is alkyl. When present, the optional cyclic structures formed from two or more of R₁-R₄ and/or two or more of R₅-R₈ are independently selected from the group consisting of cycloalkyl, heterocycloalkyl, cycloalkenyl, heterocycloalkenyl, heterocycle, aryl, and heteroaryl.

As described above, the perylenequinone photoredox catalyst is placed in an excited state via irradiation. The perylenequinone photoredox catalyst, in some embodiments, is irradiated with light having a wavelength in the visible region and/or near-UV region of the electromagnetic spectrum to induce the excited state. For example, the perylenequinone photoredox catalyst can be irradiated with light having a wavelength of 300 nm to 800 nm, in some embodiments. The perylenequinone photoredox catalyst, in some embodiments, is simultaneously irradiated with two separate radiation profiles or sources. The perylenequinone photoredox catalyst, for example, can be irradiated at 405 nm and 730 nm. Use of such simultaneous radiation can improve yield of the alkylated imine by enhancing single electron transfer (SET) from the reduced perylenequinone photoredox catalyst to the alkylated imine substrate through an excited state reduction, as described further below.

The perylenequinone photoredox catalyst can be present in the reaction mixture in any amount consistent with the technical objectives described herein. Amount of perylenequinone photoredox catalyst can be dependent on several considerations including the identity of the alkyl source and/or imine, and specific identity of the perylenequinone employed as the photoredox catalyst. In some embodiments, the perylenequinone photoredox catalyst is present in an amount of 0.01 mol. % to 5 mol. %.

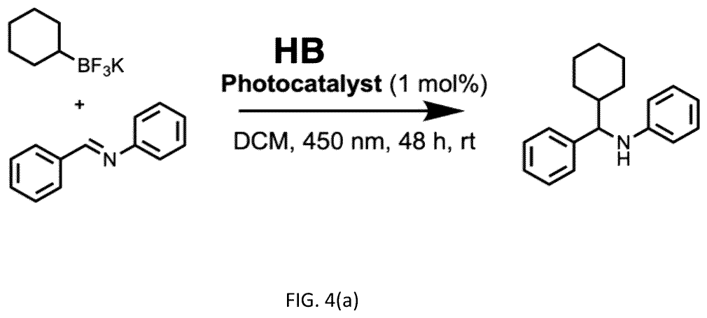

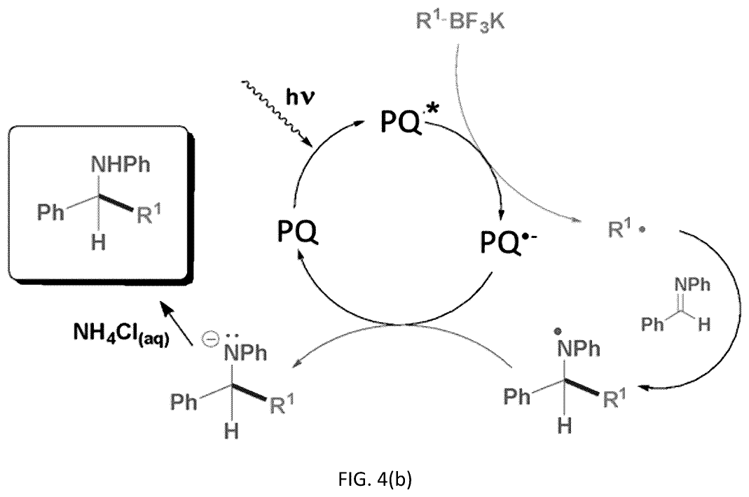

FIG. 3 illustrates various imine substrates and alkyl sources according some embodiments herein. Moreover, FIG. 4(a) provides a reaction scheme for alkylation of diphenylimine, according to some embodiments. FIG. 4(b) illustrates a mechanism for photocatalytic alkylation of diphenylimine, according to some embodiments. As illustrated in FIG. 4(b), the perylenequinone photoredox catalyst is excited by irradiation with visible light. The excited state perylenequinone photoredox catalyst oxidizes the alkyl source (R¹-BF₃K) to provide an alkyl radical, R¹· and a reduced perylenequinone photoredox catalyst. The alkyl radical is reacted or added to the imine substrate, followed by single electron transfer (SET) from the reduced perylenequinone photoredox catalyst to the alkylated imine substrate. The SET regenerates the perylenequinone photoredox catalyst in the ground state.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A redox flow battery comprising:
an anolyte and a catholyte, wherein at least one of the anolyte and catholyte comprises perylenequinone electrolyte.

2. The redox flow battery of claim 1, wherein the perylenequinone electrolyte is of Formula I: 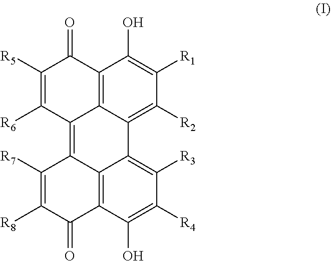
wherein R₁-R₈ are independently selected from the group consisting of hydrogen, alkyl, alkenyl, heteroalkyl, heteroalkenyl, cycloalkyl, heterocycloalkyl, heterocycle, aryl, heteroaryl, amine, halo, hydroxy, alkoxy, amide, ether, ketone, —C(O)O^{—}, —C(O)OR₉, and —R₁₀OH, wherein R₉ is selected from the group consisting of hydrogen and alkyl, and Rio is alkyl; and
wherein two or more of R₁-R₄ may optionally combine to form one or more cyclic structures optionally substituted with one or more substituents selected from the group consisting of alkyl, alkoxy, hydroxy, imine, amine, amide, ketone, —C(O)O^{—}, —C(O)OR₁₁, and —R₁₂OH, wherein Rn is selected from the group consisting of hydrogen and alkyl, and R₁₂ is alkyl; and
wherein two or more of R₅-R₈ may optionally combine to form one or more cyclic structures optionally substituted with one or more substituents selected from the group consisting of alkyl, alkoxy, hydroxy, imine, amine, amide, ketone, —C(O)O⁻, —C(O)OR₁₃, and —R₁₄OH, wherein R₁₃ is selected from the group consisting of hydrogen and alkyl, and R₁₄ is alkyl.

3. The redox flow battery of claim 1 having an open circuit voltage greater than 1.5V.

4. The redox flow battery of claim 1 having an open circuit voltage of 1.5V to 3V.

5. The redox flow battery of claim 1 having an open circuit voltage of 1.6V to 2.5V.

6. The redox flow battery of claim 2, wherein the perylenequinone electrolyte is naturally occurring.

7. The redox flow battery of claim 6, wherein the perylenequinone electrolyte is selected from hypocrellin A and hypocrellin B.

8. The redox flow battery of claim 1, wherein the anolyte and/or catholyte comprises organic solvent.

9. The redox flow battery of claim 8, wherein the organic solvent is polar aprotic organic solvent.

10. The redox flow battery of claim 1, wherein the anolyte and/or catholyte comprises aqueous or aqueous-based solvent.

11. The redox flow battery of claim 1 having a symmetric architecture.

12. The redox flow battery of claim 11, wherein a membrane separating the anolyte and catholyte is absent.

13. The redox flow battery of claim 12, wherein the anolyte and catholyte comprise immiscible solvents.

14. The redox flow battery of claim 1 having an asymmetric architecture.

15. The redox flow battery of claim 14, wherein the anolyte and catholyte comprise differing perylenequinone electrolytes.

16. The redox flow battery of claim 14, wherein the anolyte comprises a perylenequinone electrolyte, and the catholyte comprises non-perylenequinone electrolyte.

17. The redox flow battery of claim 14, wherein the catholyte comprises a perylenequinone electrolyte, and the anolyte comprises non-perylenequinone electrolyte.

18. A method of alkylation comprising:
providing a reaction mixture including a perylenequinone photoredox catalyst, an alkyl source, and a substrate;
placing the perylenequinone photoredox catalyst in an excited state via irradiation of the reaction mixture;
oxidizing the alkyl source with the excited perylenequinone photoredox catalyst to provide an alkyl radical and reduced perylenequinone photoredox catalyst;
reacting the alkyl radical with the substrate followed by single electron transfer from the reduced perylenequinone photoredox catalyst to the alkylated substrate.

19. The method of claim 18, wherein the perylenequinone photoredox catalyst is of Formula I: 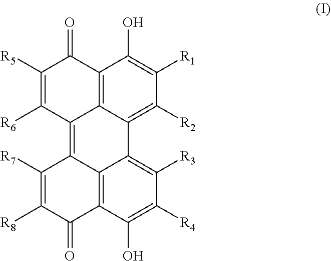
wherein R₁-R₈ are independently selected from the group consisting of hydrogen, alkyl, alkenyl, heteroalkyl, heteroalkenyl, cycloalkyl, heterocycloalkyl, heterocycle, aryl, heteroaryl, amine, halo, hydroxy, alkoxy, amide, ether, ketone, —C(O)O^{—}, —C(O)OR₉, and —R₁₀OH, wherein R₉ is selected from the group consisting of hydrogen and alkyl, and Rio is alkyl; and
wherein two or more of R₁-R₄ may optionally combine to form one or more cyclic structures optionally substituted with one or more substituents selected from the group consisting of alkyl, alkoxy, hydroxy, imine, amine, amide, ketone, —C(O)O^{—}, —C(O)OR₁₁, and —R₁₂OH, wherein R₁₁ is selected from the group consisting of hydrogen and alkyl, and R₁₂ is alkyl; and
wherein two or more of R₅-R₈ may optionally combine to form one or more cyclic structures optionally substituted with one or more substituents selected from the group consisting of alkyl, alkoxy, hydroxy, imine, amine, amide, ketone, —C(O)O⁻, —C(O)OR₁₃, and —R₁₄OH, wherein R₁₃ is selected from the group consisting of hydrogen and alkyl, and R₁₄ is alkyl.

20. The method of claim 18, wherein the perylenequinone photoredox catalyst is naturally occurring.

21. The method of claim 18, wherein the perylenequinone photoredox catalyst is selected from the group consisting of ent-shiraichrome A, hypocrellin B, hypomycin A, hypomycin C, and hypomycin E.

22. The method of claim 18, wherein the perylenequinone photoredox catalyst is irradiated with light having a wavelength in the near-UV or visible region of the electromagnetic spectrum.

23. The method of claim 22, wherein the perylenequinone photoredox catalyst can be irradiated with light having a wavelength of 300 nm to 700 nm.

24. The method of claim 18, wherein the substrate is an imine.

25. The method of claim 24, wherein the substrate is an aryl-imine.

26. The method of claim 18, wherein the perylenequinone photoredox catalyst is present in the reaction mixture in an amount of 0.01 mol. % to 5 mol. %.

27. The method of claim 18, wherein the alkyl source is R-BF₃K, wherein R is selected from the group consisting of alkyl, cycloalkyl, heterocycle, alkenyl, alkyl-aryl, and alkyl-heteroaryl.
